(19) United States
(12) Patent Application Publication
(10) Pub. No.: US 2026/0092681 A1
(43) Pub. Date: Apr. 2, 2026

(54) HEAT EXCHANGER SYSTEM AND/OR METHOD THEREFOR

(71) Applicant: Verne Inc., San Francisco, CA (US)

(72) Inventors: Kara Zhang, San Francisco, CA (US); Vincent Heloin, San Francisco, CA (US); Enrique Nuñez Garcia, San Francisco, CA (US); David E. Jaramillo, San Francisco, CA (US)

(73) Assignee: Verne Inc., San Francisco, CA (US)

(21) Appl. No.: 19/347,595

(22) Filed: Oct. 1, 2025

Related U.S. Application Data
(60) Provisional application No. 63/701,781, filed on Oct. 1, 2024.

(51) Int. Cl. F17C 13/00

(52) U.S. Cl. CPC F17C 13/00; F17C 2221/012; F17C 2221/014; F17C 2223/0115; F17C 2223/0123; F17C 2223/036; F17C 2225/0115; F17C 2227/0353; F17C 2265/012

(57) ABSTRACT

The system can include: a heat exchanger, a set of valves, a sensor suite, and a controller The system can optionally include or be used with a catalyst, a set of barriers, and/or an enclosure. However, the system can additionally or alternatively include any other suitable set of components. The system functions to facilitate cooling of a pressurized fluid (e.g., high pressure hydrogen gas). Additionally or alternatively, the system can function to catalyze fluid state change (e.g., hydrogen spin conversion, etc.) within the pressurized fluid. For example, the system can be used to convert hydrogen from a high-pressure gaseous hydrogen (GH₂) state or high-pressure supercritical hydrogen (ScH₂) state to the cryo-compressed hydrogen (CcH₂) state without hydrogen liquefaction (fluid state transition to liquid hydrogen, LH₂).

### CROSS REFERENCE TO RELATED APPLICATIONS

This application claims the benefit of U.S. Provisional Application number 63/701,781, filed 1 Oct. 2024, which is incorporated herein in its entirety by this reference.

This application is related to U.S. application Ser. No. 18/842,615, filed 29 Aug. 2024, which is incorporated herein in its entirety by this reference.

### STATEMENT OF GOVERNMENT SUPPORT

This invention was made with government support under Award Number DE-AR0001670 awarded by the Department of Energy. The government has certain rights in the invention.

### TECHNICAL FIELD

This invention relates generally to the cryogenics field, and more specifically to a new and useful heat exchange system and/or method in the cryogenics field.

### BRIEF DESCRIPTION OF THE FIGURES

FIG. 1 is a schematic representation of a variant of the system.

FIG. 2 is a schematic representation of fluid flow in a variant of the system.

FIG. 3 is an example graph of pressurized fluid temperature for first fluid within a first fluid channel of the heat exchanger in a variant of the system.

FIG. 4 is an illustrative example of the catalyst within a fluid channel of the first set of fluid channels.

FIG. 5 is an illustrative example of the catalyst within a fluid channel of the first set of fluid channels.

FIG. 6 is an example schematic of a balance of plant system in a variant of the system.

FIG. 7 is a view of a variant of the system.

FIG. 8 is a schematic representation of fluid flow channels in a variant of the system.

FIG. 9 is a schematic representation of a variant of the method.

FIG. 10 is a schematic representation of a variant of valves and orifices along first and second fluid streams.

FIG. 11 is an illustrative example of fluid flow in a variant of the method.

FIG. 12 is an illustrative example of fluid flow through a variant of the system.

FIG. 13 is an example graph of hydrogen spin conversion energy as a function of temperature.

FIG. 14 is an example graph of equilibrium ortho-percentage of H2 as a function of temperature when in equilibrium.

FIG. 15 is an example graph showing the spin conversion energy from H2 ortho spin to para spin and the percentage of mass flow to be converted.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Overview

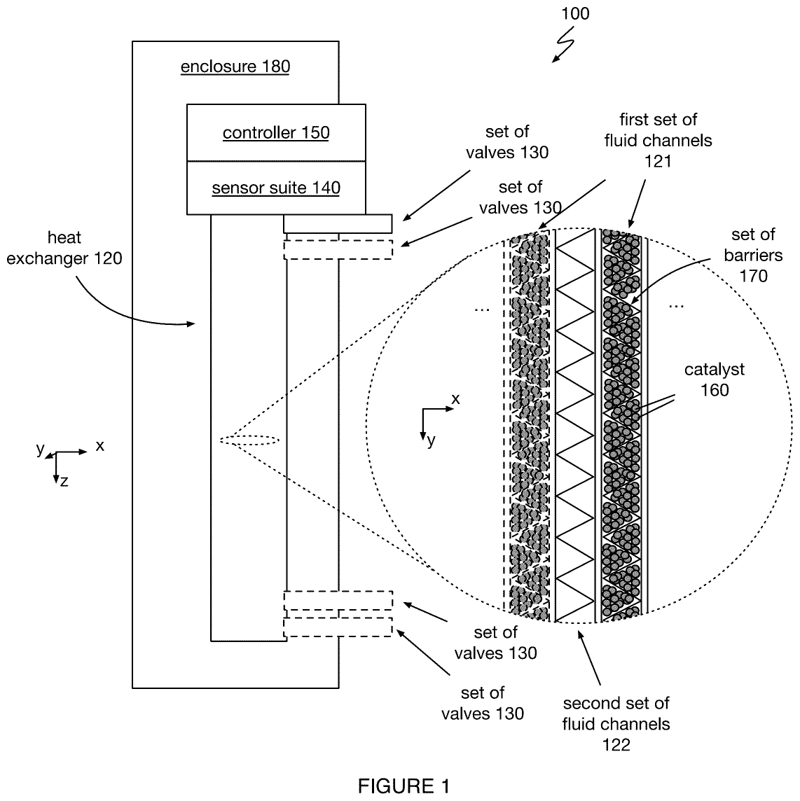

The system 100 (e.g., example shown in FIG. 1) can include: a heat exchanger 120, a set of valves 130, a sensor suite 140, and a controller 150. The system 100 can optionally include or be used with a catalyst 160, a set of barriers 170, and/or an enclosure 180. However, the system 100 can additionally or alternatively include any other suitable set of components.

The system functions to facilitate cooling of a pressurized fluid (e.g., high pressure hydrogen gas). Additionally or alternatively, the system can function to catalyze fluid state change (e.g., hydrogen spin conversion, etc.) within the pressurized fluid. For example, the system can be used to convert hydrogen from a high-pressure gaseous hydrogen (GH₂) state or high-pressure supercritical hydrogen (ScH₂) state to the cryo-compressed hydrogen (CcH₂) state without hydrogen liquefaction (fluid state transition to liquid hydrogen, LH₂). Instead, variants can rely on a second (lower temperature) fluid, such as liquid nitrogen (LN₂), to achieve a target fluid state (e.g., CcH₂ with target ortho-para ratio; such as by cooling monotonically without liquefaction). Additionally or alternatively, the system can function to facilitate the ortho-para spin conversion and/or any of combination(s) of the method elements as described in: PCT Application Number US23/80841, filed 22 Nov. 2022, and/or PCT Application Number US23/64970, filed 26 Mar. 2023, each of which is incorporated herein in its entirety by this reference.

The term “substantially” as utilized herein can mean: exactly, approximately, within a predetermined threshold or tolerance, and/or have any other suitable meaning.

In variants, the term “cryogenic” as utilized herein can refer to temperatures below 120K (e.g., cryogenic temperatures). In variants, the term “cryo-compressed” as utilized herein can refer to cryogenic temperatures and pressures above a critical pressure (e.g., 13.0 bar for hydrogen, 2.27 for helium, 27.6 bar for neon, 33.9 bar for nitrogen, 50.4 bar for oxygen, 46.0 bar for methane, 48.7 bar for ethane, 73.8 bar for carbon dioxide, etc.). In variants, “pressurized hydrogen gas” and/or “compressed hydrogen gas” can refer to hydrogen stored at pressures above 350 bar. However, the terms cryogenic and/or cryo-compressed can be otherwise suitably used or referenced herein.

### 2. Benefits

Variations of the technology can afford several benefits and/or advantages.

First, variations of this technology can facilitate fluid cooling from ambient temperatures to cryogenic temperatures (e.g., about 85K) at high pressure (e.g., 350 bar). Such variants may offer an improvement over existing cryogenic heat exchangers which operate at lower pressures (e.g., liquefaction systems are typically pressure limited below 150 bar), and thus would otherwise require multiple stages to reach target pressures for cryo-compression. To accommodate higher pressures (e.g., above 150 bar), variants may utilize unitary material constructions (e.g., diffusion bonding; solid-state fabrication) and higher strength materials (e.g., stainless steel) rather than conventional welding and brazing techniques (e.g., for multiple materials, such as copper and aluminum alloys), thus reducing the risk of first fluid leaks, crack propagation, or other pressure failure modes at cryogenic temperatures (e.g., though unitary material construction may present a tradeoff for other material properties, favoring strength and weldless manufacturing over thermal conductivity, efficiency, and/or manufacturability). For example, variants can leverage heat exchangers formed by a diffusion bonding process which can create a metallurgically continuous structure without joint interfaces susceptible to thermal stress cracking during repeated temperature cycling between ambient and cryogenic conditions.

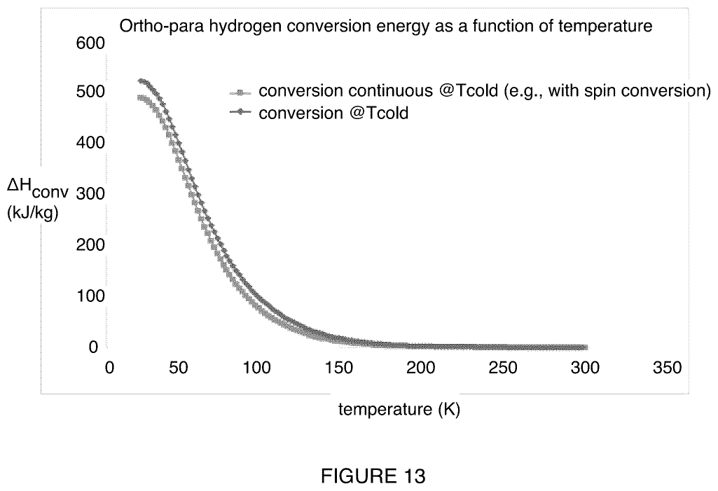

Second, variations of this technology can facilitate cryogenic cooling using a secondary fluid source (e.g., liquid nitrogen), which may be widely available and may enable operation without the additional infrastructure cost and complexity of cryogenic refrigeration systems and/or liquefaction energy requirements (e.g., phase transition energy and/or spin conversion energy such as illustrated in FIG. 13). As an example, the system can facilitate cryo-compression of supercritical hydrogen (ScH₂) or gaseous hydrogen (GH₂) within a unitary heat exchanger utilizing an LN₂ fluid stream, such as to facilitate production dispensation of first fluid as described in conjunction with the systems and/or methods as described in PCT Application US23/80841, filed 22 Nov. 2022, and/or PCT Application Number US23/64970, filed 26 Mar. 2023, each of which is incorporated herein in its entirety by this reference. The usage of liquid nitrogen enables usage of a modular and movable cooling system that can readily deploy at hydrogen infrastructure without a permanent refrigeration system, thereby reducing operational complexity.

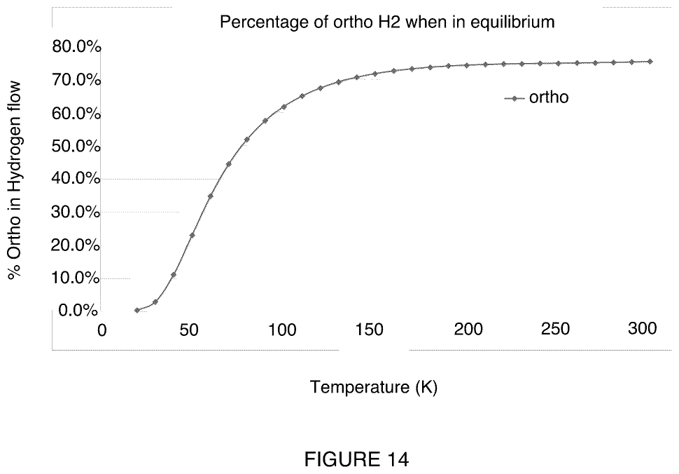

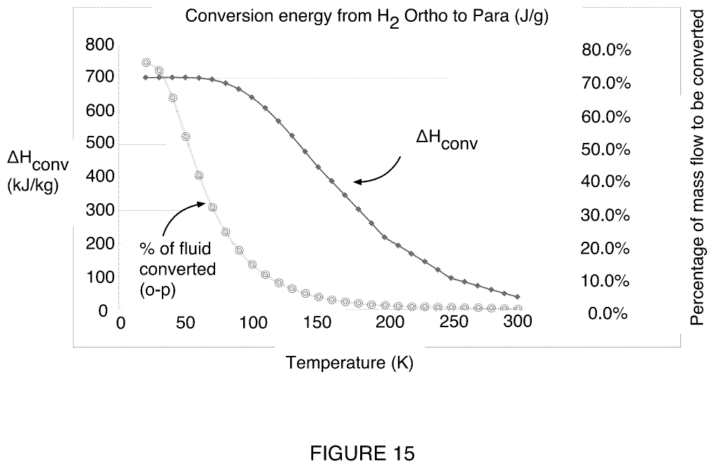

Third, variations of this technology can facilitate both cooling and fluid spin state conversion within a single heat exchanger, which may significantly improve the thermal efficiency of the system. By facilitating an exothermic spin conversion reaction, during ortho-para conversion, the system can use the cooling capacity of the second fluid to absorb both the heat of conversion (e.g., example shown in FIG. 15) from the compressed fluid as well as sensible heat. As a result, reaching a final (cryogenic) state can require less energy and/or heat removal than reaching final state by performing cooling and ortho-para conversion in separate steps, as the catalyzed ortho-para conversion of hydrogen is strongly exothermic; an example conversion energy is shown in FIG. 13. In particular, the equilibrium ratio of the hydrogen spin configurations is temperature-dependent: at room temperature (e.g., 295K, 300K, etc.), the equilibrium ratio of hydrogen fluid is 75% ortho-H₂ and 25% para-H₂, while at a LH₂ temperature (e.g., 20K, etc.), the equilibrium ratio of hydrogen fluid is 0.3% ortho-H₂ and 99.7% para-H₂ (e.g., example shown in FIG. 14).

Fourth, variations of this technology can leverage the varying effectiveness of the ortho-para conversion at different temperatures to provide cooling at an optimal energy level. Due to the temperature-dependent nature of the equilibrium ratio, an ortho-para catalyst becomes increasingly effective at lower temperatures, making integrated cooling and conversion particularly advantageous towards the outlet of the heat exchanger. In variants, the system may include an optimized concentration profile of the catalyst along the first set of fluid channels, such that more catalyst is arranged in locations at which conversion is more efficient.

Fifth, variations of this technology can simplify balance of plant (BOP) requirements through integrated thermal management control and heat exchanger design that accommodates the exothermic spin conversion process. Such variants may significantly reduce the size and mechanical complexity of fluid cryo-compression and/or dispensation installations, since the system may operate without a secondary fluid-bed reactor to catalyze the spin state change and/or without requiring hydrogen liquefaction (e.g., a thermally expensive, energy intensive process). Additionally, since the catalyzed, exothermic spin conversion may introduce a long-tailed temporal response within the thermal system (e.g., heat exchanger), variants may additionally integrate sensing and thermal controls to achieve the target fluid state (e.g., controlling valve flow rate and/or pressure) without integration into an external fluid control system. For example, the system can act as a drop-in module which enables CcH₂ fueling (e.g., via an outlet valve) given GH₂ and LN₂ fluid inputs at the set of (inlet) valves.

However, variations of the technology can additionally or alternately provide any other suitable benefits and/or advantages.

### 3. System

The system 100 can include: a heat exchanger 120, a set of valves 130, a sensor suite 140, and a controller 150. The system 100 can optionally include or be used with a catalyst 160, a set of barriers 170, and/or an enclosure 180. However, the system 100 can additionally or alternatively include any other suitable set of components.

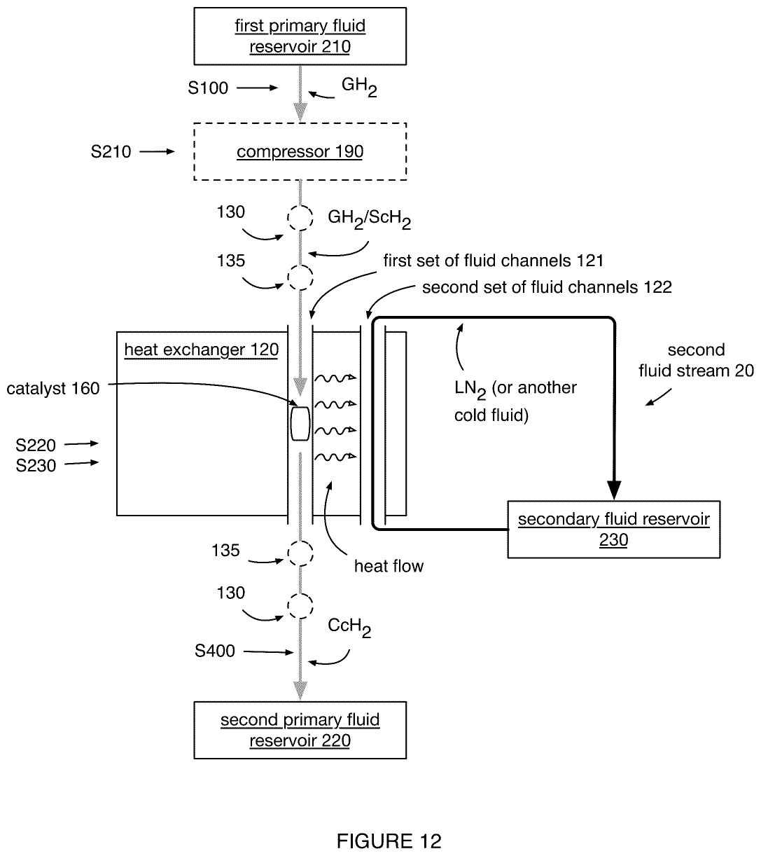

The system can additionally include and/or interface with a first primary fluid reservoir 210, a second primary fluid reservoir 220, a secondary fluid reservoir 230, and/or any other suitable reservoirs. Alternatively, the system can receive fluid from and/or dispense fluid to the aforementioned reservoirs, can be integrated along a process line fluidly coupled to the aforementioned reservoirs, and/or otherwise configured. The system functions to facilitate cooling of a first fluid (e.g., high pressure hydrogen gas; GH₂). The first fluid is preferably hydrogen (e.g., supercritical hydrogen, gaseous hydrogen, compressed hydrogen gas, etc.) but can alternatively be ammonia, methane, ethane, nitrogen, oxygen, neon, carbon dioxide, and/or any other suitable fluid). In variants, the system can cool the first fluid using a second fluid, to which heat flows from the first fluid within the heat exchanger. Examples of second fluids can include nitrogen, helium, hydrogen, neon, argon, oxygen, carbon dioxide, propane, a mixture of any of the aforementioned fluids (e.g., helium-neon, etc.), and/or any other suitable fluid. In variants, the aforementioned second fluids can be liquid, gaseous, supercritical, and/or any other suitable state. Additionally or alternatively, the system can function to catalyze a fluid state change (e.g., hydrogen spin conversion) within the pressurized fluid. In a specific example, the system can utilize a liquid nitrogen (LN₂) cooling fluid flow (e.g., 10 bar; an example is shown in FIG. 12) to convert room temperature hydrogen gas and/or supercritical fluid (e.g., 480 bar GH₂ or ScH₂) into CcH₂, with a temperature of about 80K at the outlet (e.g., ˜350 bar; less than 75% ortho-spin state, such as 55-75% ortho-spin state).

### 3.1 Heat Exchanger

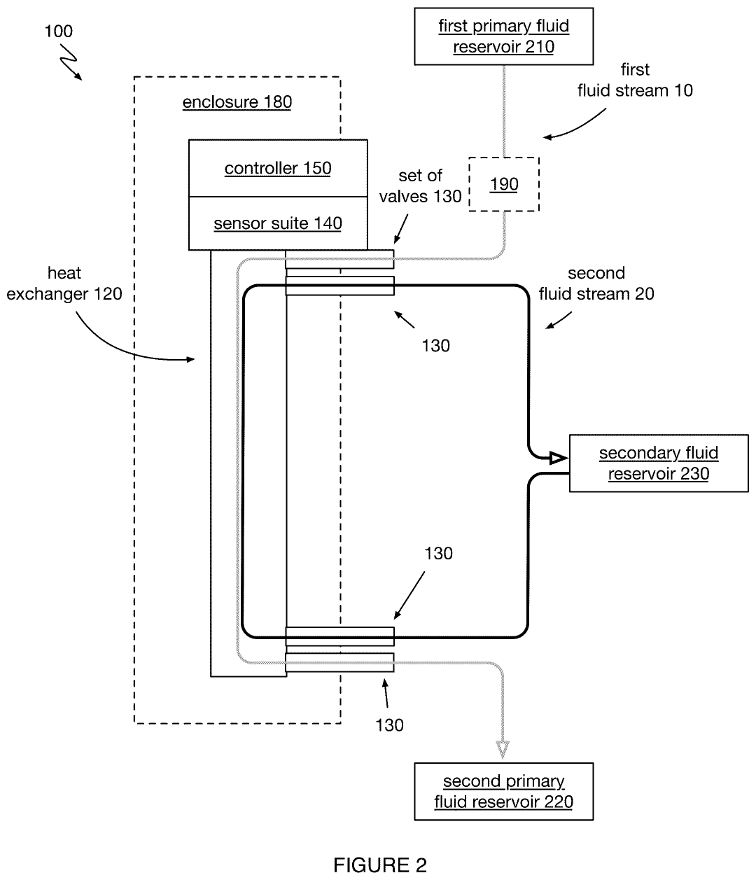

The heat exchanger (HX) (e.g., example shown in FIG. 2) functions to facilitate heat transfer between a first fluid stream 10 (e.g., a stream of a first fluid such as ScH₂, GH₂, etc.) and a second fluid stream 20 (e.g., a stream of a second fluid, such as LN₂, etc.). Additionally, in variants, the heat exchanger can function as a heat exchanger reactor which entrains a catalyst within a first set of fluid channels 121 (e.g., coupled to the first fluid stream 10), such as to catalyze the ortho-para spin conversion of hydrogen.

The heat exchanger preferably establishes thermal transfer (e.g., establishes a thermal connection) between the first and second fluid streams (e.g., and/or the first and second sets of channels containing the first and second fluid streams) but can additionally or alternatively establish a thermal connection (e.g., thermal transfer) between any other additional fluid streams (e.g., a third fluid stream containing a second secondary fluid, such as helium, etc.).

The heat exchanger can be of any suitable heat exchanger type, such as: a shell-and-tube type heat exchanger, a plate type heat exchangers, a plate-fin type heat exchanger, a plate-shell type heat exchanger, and/or any other suitable type of heat exchanger.

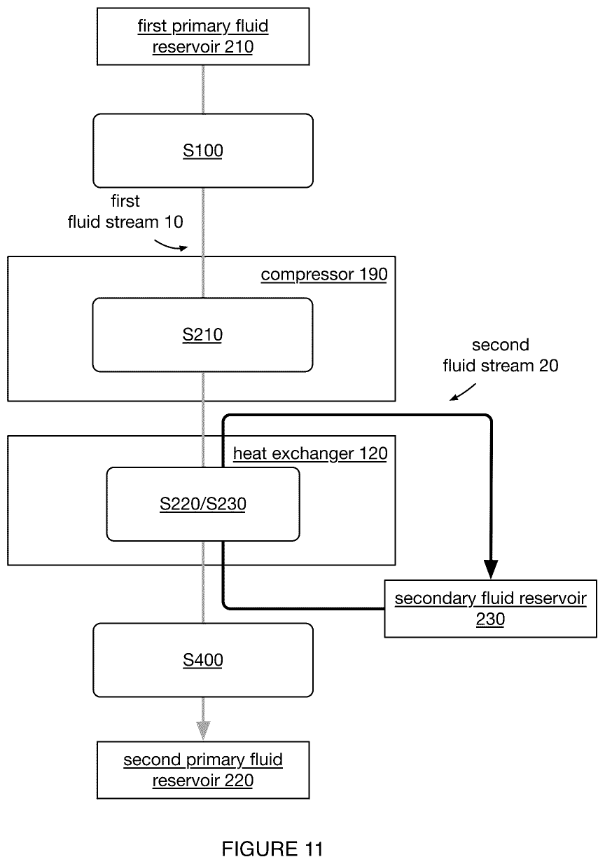

The heat exchanger preferably includes a first set of fluid channels 121 enclosing the first fluid (e.g., H2; the first set of channels extending between the first inlet and a first outlet of the heat exchanger) and a second set of channels enclosing the second fluid (e.g., N2; the second set of channels extending between a second inlet and a second outlet of the heat exchanger). The heat exchanger preferably receives the first fluid stream 10 through an inlet directly coupled to an outlet via a first set of fluid channels. The heat exchanger preferably facilitates flow of the second fluid stream at the second set of fluid channels which couples a second inlet to a second outlet. Accordingly, the first and second channels of the heat exchanger can be arranged in a parallel flow, multi-pass flow, counterflow (e.g., example shown in FIG. 11), crossflow, or other suitable relative arrangement(s). The first set of fluid channels can optionally have a different cross-sectional geometry than the second set of fluid channels (e.g., different hydraulic diameters, aspect ratios, or flow patterns to optimize heat transfer and pressure drop characteristics), alternatively, the sets of fluid channels can have the same cross-sectional geometry.

In variants, the first and second sets of channels can include surface enhancement features such as fins, turbulators, dimples, microstructures, or other heat transfer augmentation elements; alternatively, the sets of fluid channels can have interior surfaces lacking heat transfer augmentation elements. In a variant, the channels of the first set of channels can be configured with variable channel dimensions along the flow path to accommodate density changes of the first fluid as it transitions from gaseous to cryo-compressed state.

However, the system can additionally or alternatively include any other suitable type of heat exchanger (e.g., heat exchanger reactor) and/or can be otherwise configured.

The heat exchanger is preferably configured to operate across a wide cryogenic and/or non-cryogenic temperature range (e.g., temperature range for within the enclosure, within the ambient environment, within the fluid channels, etc.), such as within a range: below 70K, 70K, 77K, 85K, 100K, 110K, 120K, 300K, 320K, 350K, 400K, 420K, 423K, 425K, greater than 425K, and/or any range bounded by the aforementioned values. As an example, the heat exchanger may have a design temperature range of 77K to 423K (i.e., 320° F. to 302° F.), which may accommodate a phase change of the fluid (e.g., boiling, etc.). In an example, the temperature of the heat exchanger can decrease from ambient temperature (e.g., 295K, 300K, etc.) to cryogenic temperatures (e.g., 120K, under 120K, 77K, etc.) and back to ambient temperature within a single usage cycle.

The heat exchanger is preferably configured to operate across a wide pressure range (e.g., pressure range for within the enclosure, in the ambient environment, within the fluid channels, etc.), such as within a range: below 1 bar, 1 bar, 12.8 bar, 13 bar, 50 bar, 100 bar, 200 bar, 300 bar, 350 bar, 370 bar, 400 bar, 480 bar, 500 bar, or higher. In a first example, the heat exchanger can operate at internal pressures of 1 bar to 480 bar, which can enable direct processing of high-pressure gaseous or supercritical hydrogen without requiring intermediate pressure reduction stages that may otherwise reduce system efficiency and increase equipment complexity. In a specific example, the heat exchanger operates at an internal pressure over 150 bar. In a second example, the heat exchanger can operate at internal pressures of 300 bar to 700 bar, which can enable generation of optimal cryo-compressed hydrogen storage densities (e.g., maximum volumetric energy density, storage densities approaching that of liquid hydrogen, etc.) while maintaining sufficient pressure differential for efficient mass transfer and flow control during the simultaneous cooling and ortho-para conversion process.

Cryogenic temperatures, high pressures, large pressure fluctuations and/or large temperature fluctuations may lead to fatigue, crack propagation, and/or failure of compound constructions (e.g., multiple materials, such as brazed copper and aluminum) and/or welded seams (e.g., solid-liquid joining solid bodies) within heat exchangers. Accordingly, the HX (e.g., body and/or channels thereof) is preferably a unitary material construction (e.g., metal alloy, such as stainless steel), formed by solid-state joining of constituent geometries into a unitary body (e.g., diffusion bonding, cold welding, etc.). However, the HX can be otherwise formed by any other suitable set of materials and/or material processes.

Variants of the heat exchanger (e.g., HX reactors) can additionally include or be used in conjunction with one or more barriers 170 (e.g., a mesh filter, etc.), which function to entrain the catalyst. The barriers are preferably in the first set of fluid channels but can additionally or alternatively be in the second set of fluid channels. In an example, barriers can block movement of the catalyst downstream (e.g., in the z-direction, etc.) such that different serially-arranged sections of the first set of fluid channels can have different concentrations of the catalyst, different catalysts, etc.). In a second example, barriers can provide preload to the catalyst in the x and/or z directions (e.g., to prevent catalyst shifting, settling, etc.).

Barrier(s) 170 can be integrated into the physical construction of the heat exchanger (e.g., stainless steel integrated into the layers of the heat exchanger by solid-state joining), retained structurally or non-structurally within the heat exchanger (e.g., within the first set of fluid channels 121, etc.), and/or can be separate (e.g., mesh filters to prevent particulate egress through the inlet and/or outlet ports and/or valves, etc.). In a specific example, in which the system performs cooling and spin conversion at separate stages, a set of barriers entraining catalyst can be downstream of the heat exchanger and optionally upstream of a second heat exchanger (e.g., with any combination of properties and/or subcomponents of heat exchangers described herein).

In a specific example, the barriers can be positioned between alternating layers of the heat exchanger in a plate-fin configuration, wherein first fluid channels alternate with second fluid channels separated by heat transfer surfaces. In variants, barriers can span the full width and height of a channel cross-section, or can be partial barriers covering only a portion of the channel cross-section to enable controlled catalyst distribution.

A barrier is preferably a mesh filter but can alternatively be a perforated plate, perforated screen, ceramic porous membrane, channel constriction, internal baffle, packed bed supports, cages, sintered metal structures, woven wire cloth, expanded metal sheets, honeycomb structures, and/or any other suitable structure for retaining catalyst. The barriers can be positioned at inlet locations, outlet locations, intermediate locations along the flow path, or combinations thereof.

In variants in which the barrier is a structure containing apertures facilitating flow of a fluid stream 10 (e.g., a mesh filter, perforated screen, a cage, etc.), an aperture size (e.g., mesh size, perforation diameter, bar spacing, etc.) can be: smaller than the catalyst and/or minimum particulate size thereof, the same size as the catalyst, and/or any other suitable size. For example, the aperture size can be less than 2 microns, 2 microns, 3 microns, 5 microns, 6 microns, 8 microns, 10 microns, 15 microns, greater than 15 microns, any open or closed range bounded by the aforementioned values, and/or any other suitable size. In particular, an aperture size between 3 microns and 6 microns may be particularly advantageous to reduce risk of hardware damage while also reducing the BOP impact (e.g., reduce pressure head and fluid stream impact; for a catalyst particulate of about 5-10 mm to be entrained).

However, the heat exchanger can additionally exclude barriers entraining catalyst (e.g., mesh filters) be configured to operate with external (e.g., downstream) barriers entraining mesh, and/or can be otherwise configured.

However, the heat exchanger can otherwise entrain the catalyst.

In a specific example, the heat exchanger can be a diffusion-bonded, stainless-steel, plate-fin type heat exchanger reactor (e.g., entraining a ferrous oxide catalyst; with mesh filters integrated into the HX layers). In a specific example, the heat transfer surfaces defining the first set of channels and second set of channels are diffusion-bonded to each other.

However, the system can include any other suitable heat exchanger(s).

### 3.2 Set of Valves 130

The set of valves 130 functions to control the flow of fluids within the heat exchanger system. The valves can be configured to regulate, direct, and/or restrict the first and second fluid streams through the heat exchanger and/or to the set of sensors. valves can be located at inlets of the heat exchanger (e.g., at an inlet fluidly coupled to the first set of channels, at an inlet fluidly coupled to the second set of channels, etc.), at outlets of the heat exchanger (e.g., at an outlet fluidly coupled to the first set of channels, at an outlet fluidly coupled to the second set of channels, etc.), within the heat exchanger (e.g., along the first and/or second sets of channels, etc.) and/or at any other suitable location.

The set of valves can include: inlet valves, outlet valves, bypass valves, pressure balancing valves (e.g., static, dynamic, calibrated, etc.), check valves, flow control valves, pressure regulators, pressure relief valves, gate valves, ball valves, butterfly valves, globe valves, diaphragm valves, manual valves, electronic valves (e.g., solenoid valves, flow control, etc.), pneumatic valves, and/or any other suitable type(s) of valves in any suitable arrangement(s). The set of valves can optionally include or be used in conjunction with any suitable types of heat exchanger manifolds at the inlet(s) and/or outlet(s). Individual valves are preferably operable across the wide temperature range (e.g., 77K-330K) of the system, but can additionally and/or alternatively be constructed from other suitable materials compatible with the working fluids and operating conditions of the heat exchanger. In a specific example, a valve is a cryogenic flow control valve. For example, valve materials may still require hydrogen embrittlement resistance given the wide range of potential operation temperatures and pressures. Additionally, valves are preferably insulated within the enclosure and/or by various insulation material layers, but can be otherwise configured.

In examples, valves of the set of valves are rated to high pressures and low temperatures. For example, a valve can have a pressure rating of 1 bar, 12.8 bar, 13 bar, 50 bar, 100 bar, 200 bar, 300 bar, 350 bar, 370 bar, 400 bar, 480 bar, 500 bar, a pressure rating within an open or closed range bounded by the aforementioned values, and/or any other suitable pressure rating. In a specific example, a valve can be rated for cryogenic temperatures and pressures over 300 bar.

In a preferred variant, the set of valves can be automated, controlled by electronic or pneumatic actuators that respond to signals from the controller (e.g., dynamically, based on sensor measurements, etc.). Accordingly, the set of valves can include or be used in conjunction with the sensors to provide feedback on valve position, flow rates, fluid temperatures, and/or pressure differentials across the valves (e.g., at HX inlets and outlets), to be used by the controller for automated thermal management and system monitoring. For example, the valves can be configured to operate in various sequences or control schemes to achieve desired flow characteristics and thermal management of the heat exchanger.

Alternatively, valves can be operated manually and/or by manual setpoint adjustments, and/or can be otherwise controlled.

In variants, the set of valves can include and/or be arranged in line with a set of orifices.

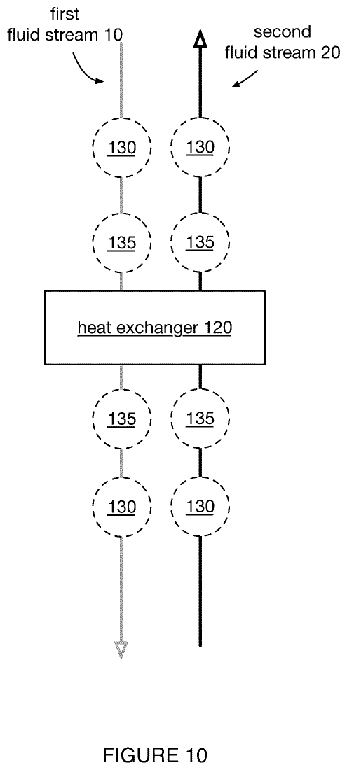

The set of orifices 135 (e.g., example shown in FIG. 10) functions to regulate the flow of fluids at and/or proximal to valves of the system. In variants, the orifices can provide calibrated flow restrictions that create predictable pressure differentials and flow rates based on upstream pressure conditions. The set of orifices can be positioned upstream of the heat exchanger, downstream of the heat exchanger, and/or integrated within the heat exchanger flow channels. In preferred variants, orifices can be arranged downstream of the heat exchanger to provide flow restriction while maintaining high operating pressure within the heat exchanger during operation (e.g., “breaking the pressure” downstream rather than upstream; keeping the pressure in the heat exchanger rather than in other system components fluidly connected to the heat exchanger; ensuring a higher degree of control of the velocity through the heat exchanger block; limiting the risk of attrition of the catalyst, etc.). However, the orifices can alternatively be upstream.

The orifices can have fixed or variable aperture sizes. In variants in which the aperture sizes of the orifices are fixed, the aperture size of the orifice can be calibrated based on the expected operating pressures and target flow rates for the system. For example, orifice sizing can be determined based on standard orifice flow equations, which variants have validated to provide accurate flow predictions even under the extreme conditions of high pressure (e.g., 350+ bar) and cryogenic temperatures (e.g., 77-85K). In such variants, predicted flow can enable simplified control schemes that wholly or partially rely on orifice-based flow restriction rather than complex electronic flow control valves. In variants in which the aperture sizes are variable, the aperture size of the orifice can be dynamically calculated and changed by the controller (e.g., as part of balance of plant operations, etc.). In such variants, cryogenic control valves can be used as orifices, and the opening can be adjusted dynamically by a controller based on a desired flowrate, pressure, pressure drop, temperature, temperature drop, and/or any other suitable parameters. Accordingly, the set of orifices can include or be used in conjunction with the sensors to provide feedback on valve position, flow rates, fluid temperatures, and/or pressure differentials across the valves (e.g., at HX inlets and outlets), to be used by the controller for automated thermal management and system monitoring. For example, the orifices can be configured to operate in various sequences or control schemes to achieve desired flow characteristics and thermal management of the heat exchanger.

However, the set of orifices may be otherwise configured.

However, the set of valves may be otherwise configured to suit the specific requirements of the heat exchanger system and its operating environment.

### 3.3 Sensor Suite 140

The sensor suite 140 functions to sample information about various parameters within and around the heat exchanger to facilitate BOP. The sensor suite can include: temperature sensors, pressure sensors, mass flow sensors, valve feedback sensors (e.g., valve position, etc.), diagnostic sensors (e.g., vibration sensors, strain gauges, inertial sensing, leak detectors, optical sensors, etc.), and/or any other suitable set of sensors. Sensors of the sensor suite can be arranged at any suitable positions along fluid lines, within the enclosure, outside the enclosure, and/or in any other suitable arrangement(s). For example, sensors can be arranged at each valve, inlet, and outlet of the heat exchanger, within/along the catalyst bed(s), and in the surrounding enclosure.

The temperature sensors can include, for example, thermocouples, silicon diodes, resistance temperature detectors (RTDs), infrared sensors, and/or any other suitable sensors. Temperature sensors are preferably positioned to monitor the temperature of the working fluid(s), catalyst, and enclosure, but can additionally and/or alternatively be placed in other suitable locations. As an example, HX thermal systems may typically be characterized by monitoring flow rates along with temperatures at the inlet and outlet, which may be sufficient for thermal control stability in typical systems. Variants can utilize this sensor arrangement, and additionally utilize sensors along the length of the heat exchanger (e.g., catalyst bed) to facilitate thermal state characterization and dynamic control to accommodate the exothermic spin-state conversion. For instance, temperature sensors can be mounted along length the heat exchanger and/or process line tube (e.g., within catalyst bed and/or thermally coupled to the catalyst bed) using thermally conductive bonding agents and/or mounts (e.g., copper mount with a thermally conductive epoxy, etc.).

In variants, a temperature sensor(s) can be fluidly and/or thermally coupled to the process line fluid and/or the first and second fluid streams (i.e. insert the probe into the process line to contact the first fluid direction, sealed using welding or removable fittings). Additionally or alternatively, temperature sensors can be thermally coupled to the fluid streams at various points using thermowells (e.g., welded into the process line or attached using fittings, with the temperature sensor inserted into the thermowell, with thermal grease to improve conduction and prevent accumulation of air/water vapor in the volume of the thermowell).

However, temperature sensors can be otherwise distributed, arranged and/or integrated within the system.

The pressure sensors in the sensor suite function to monitor pressure levels within the system. These can include, for example, gauge pressure sensors, differential pressure sensors (e.g., measure pressure drop across a component such as the heat exchanger, a calibrated orifice, or any other component), absolute pressure sensors, static pressure sensors, dynamic pressure sensors, piezoelectric sensors, capacitive sensors, strain gauge sensors, optical sensors, and/or any other suitable sensors. Pressure sensors can be installed at various points in the fluid flow path, for example, before and after the catalyst bed, at the heat exchanger inlets and outlets, alongside temperature sensors, and/or at any other suitable positions within the system and/or fluid streams. However, the system can include any other suitable pressure sensors and/or distribution thereof.

Flow rate sensors in the sensor suite function to measure the flow rate(s) through the heat exchanger (e.g., first and second fluid streams). Flow rate sensors can include: differential pressure flow meters, ultrasonic flow meters, turbine flow meters, mass flow meters, vortex flow meters, and/or Coriolis flow meters. Flow rate sensors can be positioned in the inlet and outlet pipes of the heat exchanger, in series and/or in parallel with the process line, and/or in any other suitable arrangement(s). In variants, flow rate sensors can additionally or alternatively be used in conjunction with heating elements, pressure regulators, and/or any other suitable set of fluid regulation hardware/valves. For example, mass flow meters/controllers may not typically be designed to operate at cryogenic temperatures, and may operate in series with an upstream vaporizer and pressure regulator to decrease the temperature and pressure, respectively, of the gas stream entering the flow rate sensor. For example, the flow rate sensor can be integrated into a digital mass flow rate controller (e.g., a digital mass flow controller which measures discrete absolute pressure of a laminar flow stream).

The sensors of the sensor suite are preferably communicatively coupled with the controller, providing real-time data for system monitoring and control. Sensors are preferably connected to the controller via wired connections, but can additionally and/or alternatively use wireless communication methods and/or can be otherwise configured. However, the sensor suite may be configured in other suitable ways to obtain the necessary information for heat exchanger operation and control.

### 3.4 Controller 150

The controller functions to monitor and regulate the operations of the heat exchanger system. The controller can receive input from the sensor suite and process this information to make decisions about system operation. The controller can be configured to adjust the set of valves based on the received sensor data, for example, to control the flow of fluids or gasses through the heat exchanger. The controller can include a microprocessor or other suitable computing device. It can be programmed with algorithms and logic to interpret sensor data and determine appropriate actions. The controller is preferably electronic, but can additionally and/or alternatively be mechanical or pneumatic.

In a first variant, the controller can be integrated directly into the heat exchanger enclosure. This configuration can allow for compact design and reduced latency in control responses. In a second variant, the controller can be a separate unit connected to the heat exchanger system via wired or wireless communication channels. However, the controller can be otherwise configured.

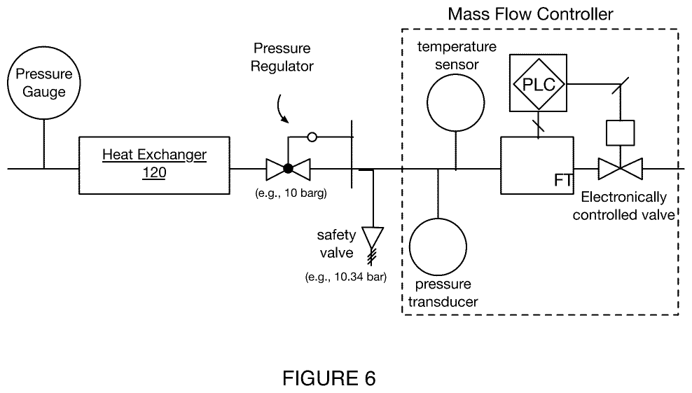

The controller can operate with any suitable control schemes, such as feedback controls (e.g., linear, non-linear, etc.), feedforward controls, open-loop control elements, optimal control techniques (e.g., MPC, LQG, etc.), robust control techniques (e.g., H-infinity loop shaping), stochastic control techniques, adaptive control, hierarchical control techniques, intelligent control (e.g., ANNs, fuzzy logic, ML, Bayesian probability, evolutionary computation and genetic algorithms, and/or a combination thereof, etc.), and/or any suitable combination thereof. For example, the system can implement a PID control scheme with a programmable logic controller to regulate flow rate and/or pressure (e.g., an example is shown in FIG. 6). Additionally or alternatively, the controller can control any suitable set(s) of valves based on the measurements from the sensor suite.

However, the controller can be otherwise suitably configured.

### 3.5 Catalyst 160

Variants of the system and/or heat exchanger thereof can optionally include or be used in conjunction with a catalyst 160, which functions to catalyze a conversion and/or reaction in the pressurized fluid. More preferably, the HX is packed with a hydrogen-spin catalyst such as the Ionex® catalyst from Molecular Products™ or another ferrous oxide (e.g., Fe2O3) with high surface area to enable rapid conversion. However, the system can additionally or alternatively include or be configured to operate with chromium oxide doped silica (CrO·SiO2), manganese oxides, cobalt oxides, iron hydroxide, hydrated iron oxide, iron oxide, and/or any other suitable catalyst(s). To facilitate packing assembly and density, the catalyst may have a particulate size of: less than 2 microns, 2 microns, 3 microns, 5 microns, 6 microns, 8 microns, 10 microns, 15 microns, 20 microns, 50 microns, greater than 50 microns, any open or closed range bounded by the aforementioned values, and/or any other suitable particulate size(s) or size distribution(s). For example, given the compact packaging volume of plate-fin heat exchangers (e.g., compared to typical packed bed reactors) and the high operating pressure along the system process line, it may be particularly advantageous to use a particulate size (or size distribution) between 5 microns and 10 microns (e.g., smaller than the mesh sizes used for this material in packed-bed reactors). However, any other suitable catalyst particulate size(s) and/or size distribution(s) can be used.

The catalyst is preferably arranged within the heat exchanger (i.e., heat exchanger reactor) along the process line for the first fluid stream 10 (e.g., a within the first set of fluid channels 121); however, the catalyst can alternatively be arranged downstream of the heat exchanger (e.g., as a separate component, such as a packed bed within a container). In an alternative, less preferred variant, the heat exchanger can be arranged upstream. In such variants, as the first fluid (e.g., hydrogen) flows through the heat exchanger, it is simultaneously and continuously cooled to cryogenic temperatures and converted from ortho to para spin state. Due to the varying heat of reaction with respect to temperature; it takes more energy to perform the conversion at colder temperatures. Accordingly, it may ultimately result in less energy required to perform the combined cooling and conversion from initial to final states, compared to a system that separates the cooling and conversion operations (i.e. performs the conversion once discretely once the cryogenic temperature is reached; independent heat exchanger and catalyst bed reactor). Additionally, the distribution and/or concentration of the catalyst along the process line may further increase the benefit of performing the spin conversion within a heat exchanger reactor. For example, increasing the concentration of the catalyst downstream (e.g., where the hydrogen is colder and the reaction requires more energy) may further increase the net energy benefit (e.g., increasing cooling efficiency within the process line).

In variants, the concentration of the catalyst can be uniform, nonuniform, biased upstream (e.g., greater concentration of the catalyst at the upstream, higher-temperature portion of the process line relative to a downstream portion), biased downstream (e.g., greater concentration of the catalyst at the lower-temperature, downstream portion of the process line relative to an upstream portion), asymmetrically distributed (e.g., linearly increasing density function, etc.), and/or can have any other suitable distribution within the heat exchanger reactor. In variants in which the catalyst distribution follows a trend (e.g., along the direction of first fluid flow, along the z-axis, etc.), the catalyst preferably increases in density but can alternatively decrease in density or follow any other suitable trend. In variants in which the catalyst distribution follows a trend, the trend can be monotonically increasing/decreasing, linear, non-linear, decaying, exponential, continuous, gradient-based (e.g., following predicted/observed temperature or pressure gradients), stepwise (e.g., in variants in which different cells defined by barriers have different amounts of the catalyst entrained therein), and/or any other suitable attribute.

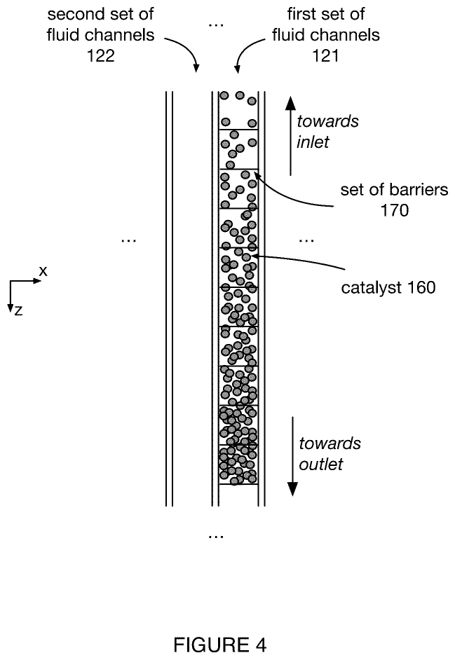

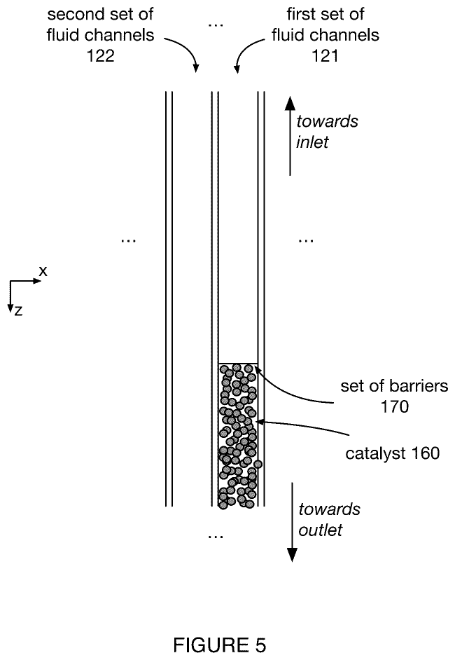

In a first specific example, the concentration (and/or density) of the catalyst monotonically increases along at least a partial length fraction of the heat exchanger reactor and/or a process flow path thereof. In a second specific example, the concentration of the catalyst increases along a z-axis (e.g., in the direction of first fluid stream flow; example shown in FIG. 4). In a third specific example, the catalyst is concentrated in a discrete region of the process flow path (e.g., in a final portion of the process flow path within the heat exchanger, in a portion of the process flow path downstream of the heat exchanger and/or outlet thereof, etc.; example shown in FIG. 5) such that overall process flow path includes a first, upstream portion with no catalyst and a second, downstream portion which includes catalyst.

In a second specific example, the concentration of the catalyst increases along a z-axis (e.g., in the direction of first fluid stream flow). However, the catalyst can have any other suitable concentration(s).

However, the variants of the system can alternatively exclude a catalyst and/or can be otherwise configured to house a catalyst within the heat exchanger.

However, the catalyst 160 can be otherwise configured.

### 3.6 Enclosure 180

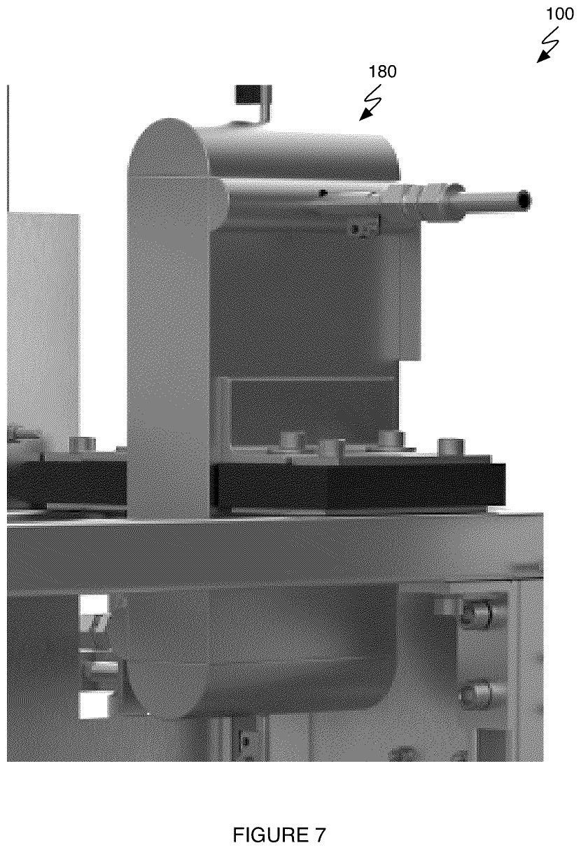

The system can optionally include or be used in conjunction with an enclosure 180 (e.g., example shown in FIG. 7), which functions to envelop the heat exchanger and cryogenic fluid channels to minimize heat transfer from/to the ambient environment (e.g., thereby improving efficiency), a vehicle (e.g., to which the enclosure is mounted), adjacent equipment, and/or any other body. Additionally, the enclosure can isolate the heat exchanger from ambient water vapor to avoid condensation, which might otherwise damage the valves, heat exchanger, and other hardware components. Additionally, the enclosure may be configured to serve as a flame retardant to reduce combustion risk in case of hydrogen leaks within an oxygen-rich environment (e.g., ambient air). The enclosure and/or HX is preferably configured to be pallet mounted, which may facilitate transport and/or modular reconfigurability. Additionally, the enclosure and/or internal mounting structure can be configured to reduce heat transfer between the environment and the HX. For example, the heat exchanger can be mounted to a strut frame (e.g., within the enclosure) by a composite mount (e.g., insulating, flame-retardant epoxy resin with fiberglass fabric reinforcement) defining an indirect thermal path from the strut frame to the HX (e.g., two offset pairs of bolts to first secure the HX to the composite and the composite to the strut frame; no bolt thermally coupling the enclosure to the heat exchanger; etc.).

In a first variant, the enclosure can be double walled, relying on an interstitial vacuum-pressure chamber to insulate the remainder of the system. For example, such variants may reduce heat losses to the surroundings, but may increase complexity and cost (e.g., relative to MLI alternatives).

In a second variant, the enclosure can include an insulation layer material at least partially enveloping the heat exchanger. In such variants, the insulation layer can include: rigid insulation materials (e.g., foamglass), flexible/expanding materials (e.g., insulation foam), foamglass insulation, foam insulation (e.g., gap-fills), thermosets, fiber insulation, composite insulation (e.g., fiberglass insulation, etc.), metal/alloyed layers (e.g., stainless steel), aerogel, glass (e.g., hollow glass microspheres, bubbles, pellets, etc.), polystyrene, superinsulation, polyimide foams, foil insulation, glass wool, mineral wool, vacuum jackets, vapor barriers, and/or any other suitable insulation material(s). In an example, the insulation layer can include a multi-layer insulation (MLI) material (e.g., including bilayers of a thin plastic and aluminized film, etc.). As an example, the enclosure can be fluidly sealed by a vapor barrier (e.g., thermoset encasement, IP65+, etc.) to reduce condensation and/or ice formation around the heat exchanger at cryogenic temperatures.

In a third variant, the enclosure can include a combination of the first and second variants.

However, the enclosure may be otherwise configured, and/or altogether excluded in some variants. An example enclosure is shown in FIG. 2.

### 3.7 Set of Reservoirs 200

The set of reservoirs functions to provide primary and/or secondary fluid for heat exchanger operation. The set of reservoirs can include a first primary fluid reservoir 210, which functions to provide the first fluid stream; a second primary fluid reservoir, which functions as a target receptacle for treated first fluid (e.g., cryo-compressed first fluid, etc.); and a secondary fluid reservoir, which functions to provide and/or treat the second fluid stream.

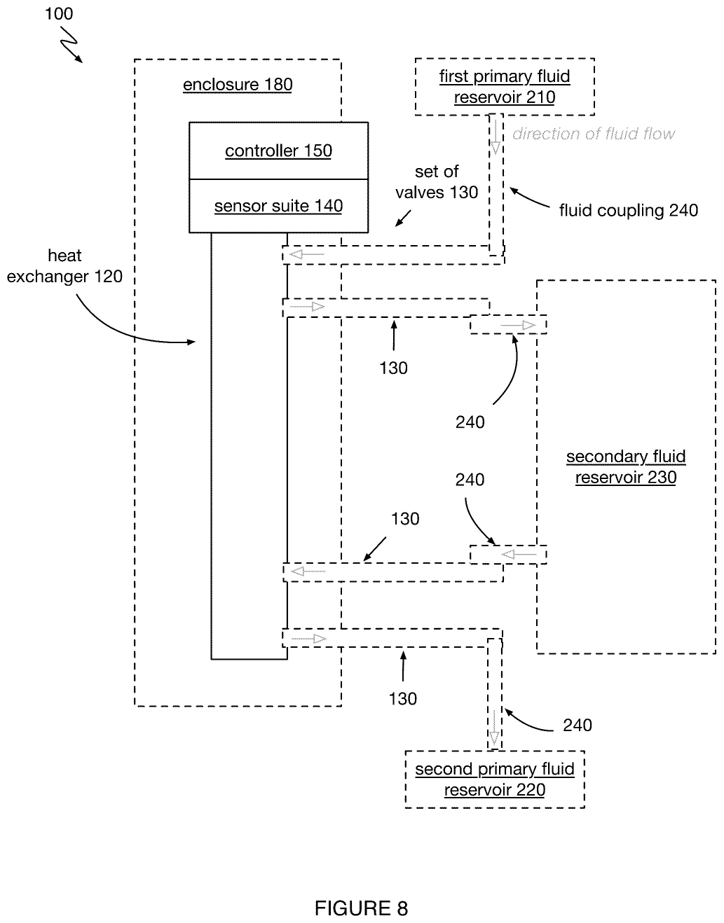

The reservoirs are preferably fluidly coupled to the heat exchanger and/or channels thereof via a set of fluid couplings 240 (e.g., example shown in FIG. 8). The fluid couplings can be mechanical couplings (e.g., threaded fittings, flanged connections, quick-disconnect couplings, compression fittings, welded joints, braised joints, bayonet connections, cam-lock couplings, sanitary clamps, union fittings, etc.), but can alternatively be any other suitable type of fluid coupling. In preferred variants, the fluid couplings enable rapid connection and disconnection of the reservoirs for maintenance, replacement, or reconfiguration of the system without permanent modification to the heat exchanger or reservoir components. Additionally, the fluid couplings are preferably configured to maintain fluid-tight seals across the operating temperature range (e.g., cryogenic to ambient temperatures) and pressure range (e.g., vacuum to high pressure, such as up to 480 bar or higher) of the system. The fluid couplings can include sealing elements such as O-rings, gaskets, metal seals, or other suitable sealing mechanisms rated for the specific fluid compatibility (e.g., hydrogen service), temperature extremes, and pressure conditions of the application. However, the reservoirs can be coupled to the heat exchanger via any other suitable fluid connection methods, including permanent connections, semi-permanent connections, and/or any other suitable coupling arrangements.

In variants, the fluid couplings can be communicatively connected to the controller 150 (e.g., for automatic coupling and decoupling). However, the fluid couplings can otherwise be manually controlled.

In variants, reservoirs can include: storage tanks, pressure vessels (e.g., composite overwrapped pressure vessels, etc.), compressed gas cylinders, pressurized gas process lines (e.g., pressurized hydrogen gas process lines), process piping, transfer lines, dewars, cryogenic storage vessels, liquid storage tanks, gas bottles, tube trailers, ISO containers, underground storage caverns, underground storage tanks, pipeline networks, compressors, pumps, vaporizers, liquefaction systems, refrigeration systems, buffer tanks, accumulator vessels, receiver tanks, surge tanks, day tanks, supply manifolds, distribution headers, mobile storage units, stationary storage installations, high-pressure storage systems (e.g., 350 bar, 480 bar, 700 bar, or higher), low-pressure storage systems, atmospheric pressure storage systems, vacuum-insulated storage systems, single-wall storage systems, double-wall storage systems, spherical storage vessels, cylindrical storage vessels, above-ground storage installations, and/or any other suitable fluid containment and/or supply systems. In examples, the reservoirs can be any combination of the aforementioned reservoir components. In a specific example, the second primary fluid reservoir (and/or the first primary fluid reservoir) is a composite overwrapped pressure vessel (COPV), optionally thermally insulated from an outer enclosure by an interstitial vacuum chamber.

In a specific example, the first primary reservoir 210 is a high-pressure storage system (e.g., compressed gas cylinders at 480 bar, tube trailers, or pipeline supply) that provides gaseous or supercritical first fluid to the heat exchanger inlet.

In a specific example, The second primary fluid reservoir 220 is a cryo-compressed first fluid storage vessel or dispensing system (e.g., a hydrogen fluid dispenser, a fuel dispensing unit, etc.) configured to receive the cooled and converted first fluid output from the heat exchanger. In another specific example, the second primary fluid reservoir is coupled (e.g., via a fluid coupling, etc.) to the heat exchanger via a cryo-compressed hydrogen fluid dispenser. In such specific examples, the hydrogen fluid dispenser can be manually or automatically controlled by the controller (e.g., via a communicative coupling).

In a specific example, the secondary fluid reservoir 230 is a liquid nitrogen (LN2) supply system, such as a cryogenic dewar, bulk liquid nitrogen tank, or LN2 delivery system that provides second fluid to the heat exchanger. In a specific example, the secondary fluid reservoir is a closed-loop system with the second set of channels of the heat exchanger. In a specific example, the secondary fluid reservoir is part of a mobile assembly which includes the heat exchanger and optionally the first primary fluid reservoir and/or a fluid coupling therewith.

However, reservoirs can alternatively include other configurations such as: integrated compressor-storage systems that compress and store the first fluid on-demand; multi-stage storage systems with intermediate pressure vessels; cascaded storage arrangements; mobile refueling units; stationary dispensing installations; liquefaction systems that convert gaseous fluids to liquid form; vaporization systems that convert liquid fluids to gaseous form; refrigeration systems for maintaining cryogenic temperatures; heating systems for temperature conditioning; filtration systems for fluid purification; drying systems for moisture removal; pressure regulation systems; flow conditioning systems; and/or any other suitable fluid handling, processing, storage, and/or delivery configurations.

### 3.8 Balance of Plant (BOP)

The system can include balance of plant (BOP) to support the operation and monitoring of the heat exchanger. The set of valves 130, set of orifices 135, sensor suite 140, and controller 150 are preferably integrated within the enclosure 180 for BOP. These systems are preferably powered by a unitary power supply (e.g., AC/DC converter coupled to an external AC power source, such as 110-120 VAC wall power), but can additionally or alternatively be powered locally (e.g., integrated battery, onboard generator, etc.), and/or otherwise powered. The integration of BOP and/or subcomponents thereof (e.g., valves, sensor suite, controller, etc.) into the enclosure can enable system modularity, such that the system can be moved between multiple second primary fluid reservoirs 220. In a specific example, the set of valves, sensor suite, and controller are part of an integrated mobile assembly (e.g., including a set of wheels for mobility, etc.).

In preferred variants, the BOP includes pressure and temperature sensors (e.g., cryogenic temperature sensors, such as PT111s, silicon diodes, thermocouples, etc.) on both the first fluid and second fluid streams. To improve the accuracy, these temperature sensors can be attached to a copper mount using thermally conductive bonding agent (e.g., thermoset; thermally conductive epoxy, etc.) affixed to the HX process line tube (e.g., by the same or a different bonding agent). Additionally, BOP preferably includes a mass flow controller on the first fluid stream. In order to achieve the target cooling and spin conversion, the controller can regulate the first fluid mass flow rate to within the design throughput for the heat exchanger (e.g., controlling valve position based on feedback from the mass flow rate sensor, temperature sensors, and/or pressure sensors). For example, this may be achieved using a dedicated flow controller (e.g., manual setpoint, automatic, etc.). As mass flow controllers/sensors for high pressure, cryogenic first fluid (e.g., hydrogen) may not be commercially available, the mass flow rate may be sampled using established hardware by reducing the pressure (e.g., a pressure regulator) and raising the temperature (e.g., to ambient temperature range) within a dedicated fluid channel. For example, the system can optionally include a vaporizer to heat the hydrogen back up to ambient temperature, with a pressure regulator to decrease the first fluid pressure before entering the mass flow meter (e.g., for calibration, testing, and/or operation in various contexts).

In a second example, the system can include or operate in conjunction with a CcH₂ dispenser with integrated flow measurement at the point of refueling (e.g., downstream of the HX).

In a third example, a GH₂ mass flow sensor can be used in conjunction with manual flow control valves and/or a GH₂ mass flow controller which integrates mass flow sensing and the electronic control valve into a single unit upstream of the heat exchanger along the process line. However, the limitation of controlling the flow by “breaking the pressure” (e.g., restrict flow rate using a valve or another restrictor to create a pressure drop) upstream is that the pressure in the HX during operation may not remain constant and/or may not remain at the designed (high) pressure, which may have a negative impact on performance.

Additionally or alternatively, the system can optionally include a calibrated orifice as the flow restriction on the downstream CcH2 side, which has the benefit of “breaking the pressure” downstream of the HX. For example, the orifice may be integrated into a bypass line to allow gross flow through the main process line during startup (i.e., when the fluid is not yet densified at the outlet and thus flow is further restricted).

Additionally, the BOP and/or subcomponents thereof may be protected from the potential contamination effects of the catalyst present in the system by a mesh particulate filter, as small particulates can damage components such as valves and pressure transducers by scoring valve seats or diaphragms. Accordingly, in addition to catalyst retention, particulate egress from the heat exchanger (e.g., at high operating pressures during normal operation) into downstream hardware can mitigated by a filter installed in the process line (e.g., within the HX and/or downstream of the HX). The aperture size of the filter can be: smaller than the catalyst and/or minimum particulate size thereof, the same size as the retention mesh, and/or any other suitable size. For example, the aperture size can be less than 2 microns, 2 microns, 3 microns, 5 microns, 6 microns, 8 microns, 10 microns, 15 microns, greater than 15 microns, any open or closed range bounded by the aforementioned values, and/or any other suitable size. In particular, an aperture size between 3 microns and 6 microns may be particularly advantageous to reduce risk of hardware damage while also reducing the BOP impact (e.g., reduce pressure head and fluid stream impact). However, any other aperture size can be used, and/or a downstream mesh may not be used (e.g., where upstream retention may sufficiently retain various catalyst materials, etc.).

However, BOP and/or subcomponents thereof can be otherwise configured.

However, the system can be otherwise configured.

### 4. Method

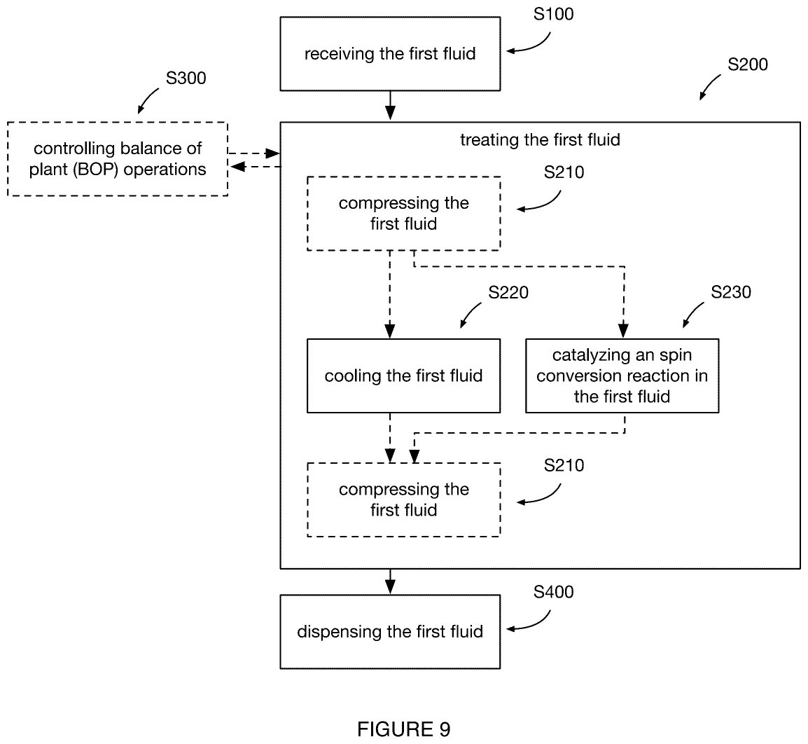

The method (e.g., example shown in FIG. 9) functions to transform the first fluid from an initial state to a cryo-compressed state. The method can include receiving the first fluid S100, treating the first fluid S200, controlling balance of plant operations S300, and dispensing the first fluid S400. The first fluid is preferably the initial state at a first fluid inlet of the heat exchanger and the cryo-compressed state at an outlet of the heat exchanger; however, the first fluid can additionally or alternatively be the initial state and/or the cryo-compressed state at any other suitable region of the heat exchanger (e.g., along a process line).

The initial state is preferably a compressed state but can alternatively be an uncompressed state. At the initial state, pressure of the first fluid can include a pressure of 1 bar, 5 bar, 12.8 bar, 13 bar, 50 bar, 100 bar, 120 bar, 200 bar, 300 bar, 350 bar, 370 bar, 400 bar, 480 bar, 500 bar, 700 bar a pressure within an open or closed range bounded by the aforementioned values, and/or any other suitable pressure.

At the initial state, temperature of the first fluid can be 230K, 240K, 250K, 260K, 270K, 280K, 290K, 295K, 300K, 310K, a temperature within an open or closed range bounded by the aforementioned values, and/or any other suitable temperature. In some variants, the first fluid can be pre-cooled (e.g., using a refrigeration system, using a heat exchanger, etc.) before entering the heat exchanger (e.g., before the initial state).

At the initial state, ortho-para concentration of the first fluid can be 75% ortho-H₂ and 25% para-H₂; however, the ortho-para concentration of the first fluid can alternatively be 70% ortho-H_{2, 80}% ortho ortho-H₂, and/or any other suitable ortho-H₂ concentration with a corresponding para-H₂ concentration remainder.

At the initial state, density of the first fluid can be 15 kg/m³, 25 kg/m³, 35 kg/m³, 40 kg/m³, 45 kg/m³, 50 kg/m³, 60 kg/m³, 70 kg/m³, a density within an open or closed range bounded by the aforementioned values, and/or any other suitable density. At the initial state, volumetric energy density of the first fluid can be 1.8 MJ/L, 2.0 MJ/L, 2.2 MJ/L, 2.4 MJ/L, 2.6 MJ/L, 2.8 MJ/L, 3.0 MJ/L, 3.2 MJ/L, a volumetric energy density within an open or closed range bounded by the aforementioned values, and/or any other suitable volumetric energy density.

At the initial state, the first fluid is preferably supercritical but can alternatively be a gas, a compressible liquid, and/or any other suitable phase.

In examples, the initial state can include ambient or elevated temperature (e.g., 273-373K), moderate to high pressure (e.g., 1-700 bar), gaseous or supercritical phase, standard atmospheric spin configuration (e.g., ˜75% ortho-hydrogen, ˜25% para-hydrogen at room temperature), standard density for the given pressure and temperature conditions, and/or any other suitable initial fluid properties. In examples, the initial state can include an ambient temperature (e.g., 290K, 295K, 300K, 310K) and/or any other suitable temperature.

At the cryo-compressed state, pressure of the first fluid can be 300 bar, 350 bar, 370 bar, 400 bar, 500 bar, 700 bar, a pressure within an open or closed range bounded by the aforementioned values, and/or any other suitable pressure.

At the cryo-compressed state, temperature of the first fluid can be 120K, 100K, 90K, 85K, 80K, 77K, 75, 70K, 65K, 63.15K, a temperature within an open or closed range bounded by the aforementioned values, and/or any other suitable temperature.

At the cryo-compressed state, ortho-para concentration of the first fluid can be 60% ortho-H₂ and 40% para-H₂; however, the ortho-para concentration of the first fluid can alternatively be 1% ortho-H₂, 5% ortho-H₂, 10% ortho-H₂, 25% ortho-H₂, 50% ortho-H₂, 55% ortho-H₂, 65% ortho-H₂, 70% ortho-H₂, 75% ortho-H₂, and/or any other suitable ortho-H₂ concentration with a corresponding para-H₂ concentration remainder. In an example in which the ortho-para concentration is above 50%, maintaining the ortho-hydrogen concentration above 50% at the cryo-compressed outlet temperature (e.g., under 120K) and pressure (e.g., 150+ bar, 300+ bar, etc.) can provide an advantageous balance between energy density optimization and conversion energy requirements. Complete conversion to para-hydrogen equilibrium may require significantly more catalyst contact time and cooling energy, while concentrations below 50% ortho-hydrogen may have volumetric energy density which is too low to justify the high-pressure cryogenic process complexity.

At the cryo-compressed state, density of the first fluid can be 60 kg/m³, 70 kg/m³, 75 kg/m³, 80 kg/m³, 85 kg/m³, greater than 85 kg/m³, a density within an open or closed range bounded by the aforementioned values, and/or any other suitable density. In a specific example, the density of the first fluid in the cry0-compressed state is higher than the density of the first fluid in the initial state. In examples, the density ratio of cry0-compressed state first fluid to initial state first fluid is 1.5:1, 2:1, 2.25:1, 2.5:1, 3:1, 5:1, a ratio within an open or closed range bounded by the aforementioned values, and/or any other suitable ratio.

At the cryo-compressed state, volumetric energy density of the first fluid can be 7.5 MJ/L, 8.0 MJ/L, 8.5 MJ/L, 9.0 MJ/L, 9.5 MJ/L, 10.0 MJ/L, greater than 10.0 MJ/L, a volumetric energy density within an open or closed range bounded by the aforementioned values, and/or any other suitable volumetric energy density. In a specific example, the volumetric energy density of the first fluid in the cry0-compressed state is higher than the volumetric energy density of the first fluid in the initial state. In examples, the energy density ratio of cryo-compressed state first fluid to initial state first fluid is 2:1, 2.5:1, 3:1, 4:1, greater than 4:1, a ratio within an open or closed range bounded by the aforementioned values, and/or any other suitable ratio.

At the cry0-compressed state, the first fluid is preferably supercritical but can alternatively be a gas, a compressible liquid, and/or any other suitable phrase.

The cryo-compressed state can include cryogenic temperature (e.g., under 120K), high pressure (e.g., 350-700 bar), dense gaseous or near-liquid phase, optimized spin configuration (e.g., >50% para-hydrogen), enhanced volumetric energy density, improved storage characteristics, reduced boil-off rates, and/or any other suitable target fluid properties. The transformation preferably occurs through controlled thermal management, pressure regulation, and catalytic conversion processes that optimize the fluid for storage, transport, and/or dispensing applications.

The method and/or processes thereof can be performed before or during reservoir filling operations. All or portions of the method can be performed in real time (e.g., responsive to a request), iteratively, concurrently, asynchronously, periodically, and/or at any other suitable time. All or portions of the method can be performed automatically, manually, semi-automatically, and/or otherwise performed.

Receiving the first fluid S100 functions to provide the primary fluid for the heat exchanger. S100 can be performed by opening a set of fluid couplings fluidly connecting the heat exchanger 120 inlet to the first primary fluid reservoir 210, by coupling a set of fluid channels attached to the heat exchange and first primary fluid reservoir, (e.g., manually or automatically establishing a mechanical connection, etc.), and/or by any other means. S100 is preferably performed by the set of fluid couplings 240, the heat exchanger 120, and the first primary fluid reservoir 210 but can additionally or alternatively be performed by any other suitable system component. S100 preferably includes receiving the first fluid at the initial state but can alternatively include receiving the first fluid at any other suitable state. In a first example, S100 includes receiving non-pressurized first fluid. In a second example, S100 includes receiving pressurized first fluid.

However, receiving the first fluid S100 can be otherwise performed.

Treating the first fluid S200 functions to control intrinsic fluid properties of the first fluid. Treating the first fluid can include pressurizing the first fluid S210, cooling the first fluid S220, catalyzing a spin conversion reaction in the first fluid S230, and/or any other suitable processes. S210, S220, and S230 can be performed at the same time, serially, cyclically (e.g., in repeating patterns such as cooling and pressurization, etc.), in overlapping sequences, and/or can be otherwise performed. S210, S220, and S230 can be performed within and/or by the same system components or different system components.

In a first example, S200 can include compressing the first fluid S210 in a first stage (e.g., using a compressor 190) and performing a dual compression-catalyzation transformation (e.g., S220 and S230) concurrently in a second stage (e.g., within a first fluid channel of the heat exchanger). In this example, the first fluid can optionally be discharged directly from the second stage. In a second example, S200 can include compressing the first fluid S210 in a first stage (e.g., using a compressor 190), cooling the first fluid S220 in a second stage (e.g., within the first fluid channel of the heat exchanger), and catalyzing the spin conversion reaction S230 in a third stage (e.g., at a volume downstream of the heat exchanger, etc.). In this example, S200 can optionally include compressing the first fluid a second time at a compressor 190 downstream of the heat exchanger.

Compressing the first fluid S210 functions to generate high-pressure, optionally supercritical fluid for treatment, transport, and/or dispensation. S210 is preferably performed by a set of compressors 190 (e.g., pumps, etc.) but can additionally or alternatively be performed by another suitable system component. S210 is preferably performed before (e.g., upstream of) S220 and/or S230 but can additionally or alternatively be performed downstream of S220 and/or S230 (e.g., by a second compressor). Compressing the first fluid can include pressurizing an unpressurized first fluid to the initial state, pressurizing a pressurized first fluid to the initial state, pressurizing a cooled fluid to the cryo-compressed state, and/or otherwise compressing the first fluid. However, compressing the first fluid S210 can be otherwise performed.

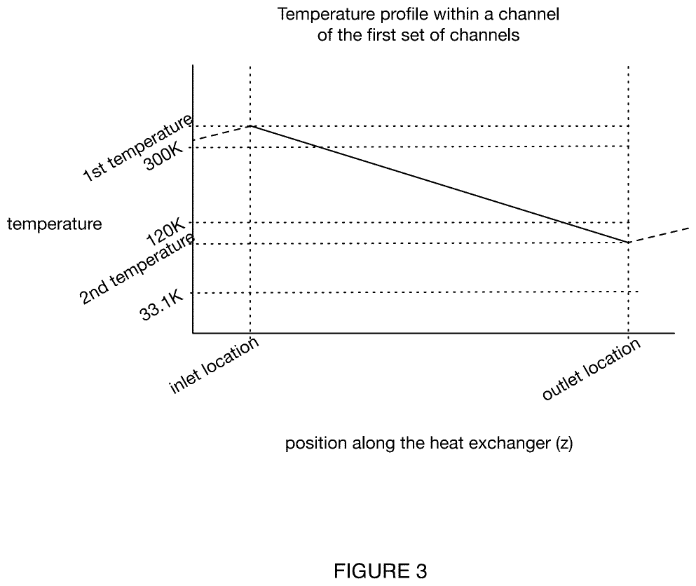

Cooling the first fluid S220 functions to convert the first fluid stream from the initial state (e.g., non-cryogenic state) to a cryogenic state or cryo-compressed state. S220 is preferably performed by the heat exchanger but can alternatively be performed by any other suitable system component. S220 preferably includes cooling the first fluid from temperatures of the initial state to temperatures of the cryo-compressed state; however, S220 can alternatively cool to any other suitable value. Cooling the first fluid is preferably performed through the entire heat exchanger (e.g., between the entire path between the inlet of the first set of channels and outlet of the first set of channels); however, cooling can otherwise be performed at only a portion of the heat exchanger, at multiple heat exchangers in series, and/or can be otherwise performed. The minimum temperature of first fluid within the heat exchanger is preferably at the outlet (or is within 1%, 3%, 5% the temperature of the first fluid at the outlet; e.g., the minimum temperature is “substantially” the temperature at the outlet), however, the minimum temperature of the first fluid within the heat exchanger can alternatively be the temperature of the first fluid at an intermediate point along the path between the inlet and the outlet. An example of temperature within a channel of the first set is shown in FIG. 3. The temperature of the first fluid can decrease monotonically, linearly, non-linearly, exponentially, asymptotically, in a stepwise manner, or according to any other suitable temperature profile along the process line. Preferably, the temperature of the first fluid within the first set of channels does not pass below the temperature of the first fluid at the outlet.

The second fluid (e.g., at a second fluid inlet of the heat exchanger) can have a temperature of 63.15K, 70°, 75K, 77K, 80K, 85K, 100K, and/or any other suitable temperature. In a specific example, the temperature of the second fluid at the inlet and/or through the process line of the heat exchanger is between 63.15K and 77K, such that the second fluid can be liquid nitrogen. In this example, operating the second fluid (e.g., liquid nitrogen) at temperatures between 63.15K and 77K can high heat transfer efficiency for hydrogen cooling while maintaining the second fluid in its liquid phase, which provides superior thermal conductivity and heat capacity compared to gaseous nitrogen, thereby reducing the required coolant flow rates and improving overall system thermal performance during the ortho-para conversion process.

However, cooling the first fluid S220 can be otherwise performed.

Catalyzing a spin conversion reaction S230 functions to reduce an overall energy of the first fluid by converting ortho-hydrogen to para-hydrogen. S220 is preferably performed by the heat exchanger 120 and/or the catalyst therein but can alternatively be performed by the catalyst independently (e.g., downstream or upstream from) of the heat exchanger. S230 preferably includes converting the first fluid from an ortho-para concentration characteristic of the initial state to an ortho-para concentration characteristic of the cryo-compressed state.

S230 is preferably performed within a same fluid channel as S220 (e.g., in variants in which the catalyst is within the first set of fluid channels) but can additionally or alternatively be performed within different fluid channels (e.g., in variants in which S220 and S230 are performed serially, within fluid channels that are fluidly up/downstream from each other). In a specific example, for a first portion of a process line through the heat exchanger, the heat exchanger performs S220 only (e.g., no catalyst is present). In this specific example, for a second portion of the process line downstream of the first portion, the heat exchanger performs both S220 and S230. However, catalyzing a spin conversion reaction in the first fluid S230 can be otherwise performed.

However, treating the first fluid can be otherwise performed.

Optionally controlling balance of plant (BOP) operations S300 functions to regulate flow rates, pressures, and temperatures of the first and second fluid streams to achieve the cryo-compressed state in the first fluid. S300 is preferably performed by the set of valves 130, sensor suite 140, the controller 150, and a set of orifices 190 but can additionally or alternatively be controlled by any other suitable components. S300 is preferably performed during continuous system operation (e.g., during S200) based on state measurements captured by the sensor suite upstream of the heat exchanger, downstream of the heat exchanger, and within the heat exchanger. S300 preferably includes adjusting the set of valves 130 and/or set of orifices 135 and/or commanding an operator to perform manual adjustments of the valves and/or orifices.

S300 can include regulating the first fluid mass flow rate through the heat exchanger to remain within design throughput parameters necessary for proper cooling and spin conversion. Such mass flow control can accommodate the exothermic nature of the catalyzed ortho-para conversion by dynamically managing thermal conditions along the process flow path. Mass flow control preferably includes automated valve and/or orifice control based on feedback from pressure and temperature measurements at the heat exchanger inlets and outlets (e.g., for the first fluid and/or second fluid).

However, S300 can otherwise be performed.

Dispensing the first fluid S400 functions to provide first fluid in the cryo-compressed state to a target volume (e.g., the second primary fluid reservoir 220). The dispensation preferably occurs through the first outlet of the heat exchanger (e.g., the outlet in fluid communication with the first set of channel, etc.) after the first fluid has been cooled to cryogenic temperatures (e.g., about 82K) and undergone full or partial ortho-para spin conversion. In an example, S400 is controlled by the controller via the valves 130 and orifices 135. In variants, the dispensation preferably occurs through filtration elements (e.g., mesh filters of 3-6 microns) arranged between the heat exchanger outlet and a system outlet to prevent catalyst particulates from contaminating downstream equipment and components. However, S400 can be otherwise performed.

### 5. Specific Examples

In a first specific example, the method can include: with a heat exchanger along a process line (e.g., in direct fluid communication with the heat exchanger between an inlet and an outlet of the heat exchanger): receiving pressurized hydrogen (e.g., GH2 or ScH2) from the process line at the inlet of the heat exchanger, wherein the pressurized hydrogen is over 290K. In this specific example, a catalyst within a first fluid channel between the inlet and an outlet, can catalyze a hydrogen spin conversion reaction in the pressurized hydrogen fluid. Concurrently, liquid nitrogen (LN2) flow within a second fluid channel thermally coupled with (e.g., in thermal communication with, etc.) the first fluid channel can drive cooling of the pressurized hydrogen fluid to an outlet temperature under 120K. Over the span of the first fluid channel (e.g., along the process line between the inlet and the outlet, a minimum temperature of the pressurized hydrogen can be the outlet temperature (e.g., the pressurized hydrogen does not drop to a lower temperature during conversion from gaseous/supercritical state to cryo-compressed state). At the outlet of the heat exchanger, the pressurized hydrogen can be at the outlet temperature before being dispensed into a second primary fluid reservoir. Optionally, in this specific example, the outlet temperature can be substantially a minimum temperature (e.g., within 1%, 2%, 5%, etc.) of the actual minimum temperature.

In a specific example, cooling the hydrogen fluid (e.g., S220) includes flowing (e.g., pumping, etc.) a cryogenic liquid (e.g., liquid nitrogen) through a set of fluid channels of the heat exchanger (e.g., the first set of fluid channels), wherein the pressurized hydrogen heats the cryogenic liquid.

In a specific example, the temperature of the cryogenic liquid is over 63.15K (e.g., the melting point of nitrogen).

In a specific example, at the inlet, the hydrogen fluid is at a pressure over 150 bar.

In a specific example, at the inlet, the hydrogen fluid is at a pressure over 300 bar.

In a specific example, the pressure of the pressurized hydrogen fluid at the inlet is above the pressure of the pressurized hydrogen at the outlet.

In a specific example, the pressurized hydrogen fluid is received at a first fluid inlet of the heat exchanger in a supercritical state.

In a specific example, catalyzing the spin conversion reaction (S230) and cooling the hydrogen fluid (S220) are performed concurrently within a region of the process line (e.g., within the same first channel and/or portion thereof, etc.).

In a specific example, the hydrogen spin conversion reaction is exothermic.

In a specific example, the hydrogen fluid at the outlet has a para-concentration of at least 50%.

In a specific example, a concentration of the catalyst increases along the process line (e.g., through the first set of fluid channels) between the inlet and the outlet of the heat exchanger.

In a specific example, the concentration of the catalyst is monotonically increasing between the inlet and the outlet.

In a specific example, the catalyst is entrained within a mesh filter along the process line.

In a specific example, the method includes dispensing the pressurized hydrogen fluid from the process line into an insulated pressure vessel fluidly coupled to the outlet of the heat exchanger.

In a second specific example, the system can include a heat exchanger defining a first channel for a first fluid (e.g., a primary fluid, such as gaseous or supercritical hydrogen, etc.) and a second channel for a second fluid (e.g., a secondary fluid, such as liquid nitrogen). In this specific example, the first channel can be coupled to a pressurized hydrogen gas process line via an inlet and a cryogenic flow control valve via an outlet. In this specific example, an ortho-para catalyst (e.g., a spin conversion catalyst) can be arranged within the first channel, such that cooling and spin conversion can happen within the same region of the heat exchanger. The second channel can be thermally coupled to the primary channel (e.g., to draw heat out of the primary channel during operation) and can be fluidly coupled to a liquid nitrogen source line, which provides the second fluid to the second channel.

In a specific example, a minimum temperature of hydrogen fluid along a fluid path directly coupling the hydrogen inlet to the hydrogen outlet is at least the temperature of the hydrogen at the hydrogen outlet.

In a specific example, the system includes a mesh between the hydrogen inlet and the hydrogen outlet, the mesh entraining a packed bed of particles of the ortho-para catalyst with a particulate size under 10 microns.

In a specific example, the heat exchanger is a diffusion-bonded, plate-fin heat exchanger.

In a specific example, the pressurized hydrogen gas process line compresses hydrogen to at least 350 bar, and the cryo-compressed hydrogen dispenser includes a flow control valve pressure (e.g., rated for at least 300 bar at cryogenic temperatures, etc.).

Alternative embodiments implement the above methods and/or processing modules in non-transitory computer-readable media, storing computer-readable instructions. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the preferred embodiments of the invention without departing from the scope of this invention defined in the following claims.

We claim:

1. A hydrogen cryo-compression method, comprising:
with a heat exchanger along a process line, the process line in direct fluid communication with the heat exchanger between an inlet and an outlet of the heat exchanger:
receiving, at the inlet of the heat exchanger, pressurized hydrogen fluid from the process line at an inlet temperature over 290K;
catalyzing a hydrogen spin conversion reaction in the pressurized hydrogen fluid using a catalyst, the catalyst arranged within the heat exchanger between the inlet and the outlet;
cooling the pressurized hydrogen fluid from the inlet temperature to an outlet temperature under 120K, wherein, at the outlet, the pressurized hydrogen fluid is at the outlet temperature and in a cryo-compressed state, wherein the outlet temperature is a minimum temperature of the pressurized hydrogen fluid along the process line; and
expelling the pressurized hydrogen fluid, in the cryo-compressed state, through the outlet of the heat exchanger.

2. The hydrogen cryo-compression method of claim 1, wherein cooling the hydrogen fluid comprises flowing a cryogenic liquid through a set of fluid channels of the heat exchanger, wherein the pressurized hydrogen heats the cryogenic liquid.

3. The hydrogen cryo-compression method of claim 2, wherein the cryogenic liquid is liquid nitrogen.

4. The hydrogen cryo-compression method of claim 2, wherein a temperature of the cryogenic liquid is over 63.15K.

5. The hydrogen cryo-compression method of claim 1, wherein at the inlet, the hydrogen fluid is at a first pressure over 150 bar.

6. The hydrogen cryo-compression method of claim 5, wherein the first pressure is at least 300 bar.

7. The hydrogen cryo-compression method of claim 1, wherein a pressure of the pressurized hydrogen fluid at the inlet is above a pressure of the pressurized hydrogen at the outlet.

8. The hydrogen cryo-compression method of claim 1, wherein the pressurized hydrogen fluid is received at the inlet in a supercritical state.

9. The hydrogen cryo-compression method of claim 1, wherein catalyzing the spin conversion reaction and cooling the hydrogen fluid are performed concurrently within a region of the process line.

10. The hydrogen cryo-compression method of claim 1, wherein the hydrogen spin conversion reaction is exothermic.

11. The hydrogen cryo-compression method of claim 1, wherein the hydrogen fluid at the outlet has a para-concentration of at least 50%.

12. The hydrogen cryo-compression method of claim 1, wherein a concentration of the catalyst increases along the process line between the inlet and the outlet.

13. The hydrogen cryo-compression method of claim 12, wherein the concentration of the catalyst is monotonically increasing between the inlet and the outlet.

14. The hydrogen cryo-compression method of claim 12, wherein the catalyst is entrained within a mesh filter along the process line.

15. The hydrogen cryo-compression method of claim 1, further comprising: dispensing the pressurized hydrogen fluid from the process line into an insulated pressure vessel fluidly coupled to the outlet of the heat exchanger.

16. A hydrogen cryo-compression system, comprising:
a heat exchanger, the heat exchanger comprising:
a hydrogen inlet fluidly coupled to a pressurized hydrogen gas process line;
a hydrogen outlet fluidly coupled to a cryo-compressed hydrogen dispenser;
a primary channel fluidly coupling the hydrogen inlet with the hydrogen outlet
an ortho-para catalyst within the primary channel; and
a secondary channel thermally coupled to the primary channel and fluidly coupled to a liquid nitrogen source flow line.

17. The hydrogen cryo-compression system of claim 16, wherein a minimum temperature of hydrogen fluid along a fluid path directly coupling the hydrogen inlet to the hydrogen outlet is at least the temperature of the hydrogen at the hydrogen outlet.

18. The hydrogen cryo-compression system of claim 16, further comprising a mesh between the hydrogen inlet and the hydrogen outlet, the mesh entraining a packed bed of particles of the ortho-para catalyst with a particulate size under 10 microns.

19. The hydrogen cryo-compression system of claim 16, wherein the heat exchanger is a diffusion-bonded, plate-fin heat exchanger.

20. The hydrogen cryo-compression system of claim 16, wherein the pressurized hydrogen gas process line compresses hydrogen to at least 350 bar, and wherein the cryo-compressed hydrogen dispenser comprises a flow control valve pressure rated for at least 300 bar.
